(19) United States
(12) Patent Application Publication
(10) Pub. No.: US 2021/0354528 A1
(43) Pub. Date: Nov. 18, 2021

(54) Invention that senses "OVERHEATED CABS IN" HOT VEHICLES"

(71) Applicant: Donald J. Opacic, Pittsburgh, PA (US)

(72) Inventor: Donald J. Opacic, Pittsburgh, PA (US)

(21) Appl. No.: 17/300,151

(22) Filed: Mar. 31, 2021

Related U.S. Application Data
(60) Provisional application No. 63/101,454, filed on May 1, 2020.

(51) Int. Cl. B60H 1/00

(52) U.S. Cl. CPC B60H 1/00807; B60H 1/00428; B60H 1/00985

(57) ABSTRACT

When a vehicles cab temperature reaches 120 degrees Fahrenheit (the medically designated point when heatstroke occurs), our invention monitors the temperature and on reaching 120 F, actuates either/or, interior or exterior, audible and visual warnings to summon help. Can control electric doors, windows and with an added on remote engine starter, start the car and turn on the air conditioner. Our invention meets the USPTO rules for being new, useful, unique and non-obvious.

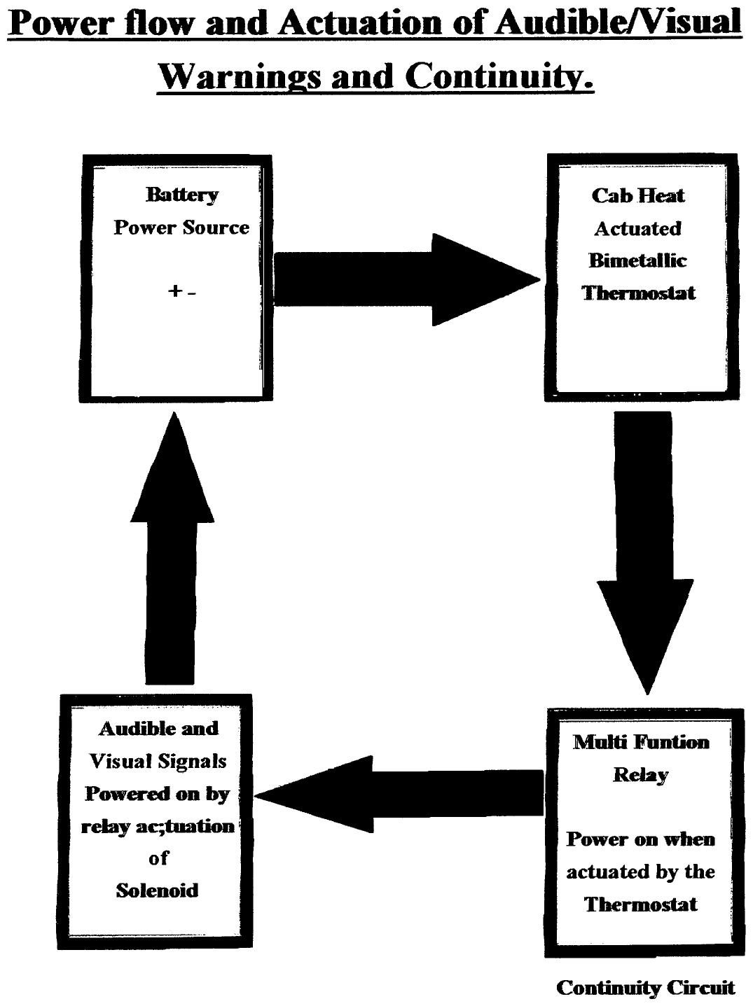

### CROSS-REFERENCE TO RELATED APPLICATIONS

This application claims benefit of provisional application No. 63/101,454, filed May 1, 2020.

### SUMMARY OF THE INVENTION

We respectfully request that our invention be granted a full patent based on the USPTO criteria that an invention be unique, new, useful and non obvious. A repurposed automotive solenoid/relay is the master control in our invention and both is and should be considered proprietary. A common bimetallic fan temperature sensor, actuated by the vehicles cab/interior temperature, closes the fans bimetallic contacts at 120 F, transmitting power to the primary coil of the solenoid coil. This doses the main contacts, turning on visible and audible warnings whose purpose is to attract rescuers and saved trapped victims. An integral continuity switch can control external components not requiring power, but provide an on/off function. Our invention is new, using only two primary components which can actuate warnings, start cooling and operate accessories. There are no commercially produced or for sale products which meet the need to summon rescuers. Existing patents pertaining to this subject, “Deaths in Hot Cars”, have in common, so many “safety and operating components”, the cost to manufacture has kept their devices off the market Until our or similar inventions become available for sale to vehicle owners, needless deaths in overheated vehicles will continue. To investigate if similar products exist for sale, we searched through Google, Amazon and EBay, without finding any of the 20 existing patents we researched, manufactured products for sale. Our invention meets the test for uniqueness, using only two prime components, a common automotive electrical relay and bimetallic fan temperature control, neither used as life saving devices prior. Standard automotive relays and bimetallic fan thermostats have been used dependably for decades. They actuate/control all of our inventions functions. Automotive solenoid/relays, rated for 40 amps, are used for supplying power to high amp draw devices like horns, emergency flashers, windows, electric locks and starters. The sequence and actuation of components by our solenoids are controlled by a bimetallic thermostat switch. On sensing a rise in a vehicles interior cab temperature at 120 F degrees Fahrenheit (medically designated start of heatstroke) the thermostat closes bimetallic contacts, sending power to the solenoid/relay. The solenoid then activates both visible and audible warnings. Incorporated is a continuity function which can be utilized to control electric doors and windows. With the addition of a remote engine starter, the continuity contacts dose, starting the engine and turn on the air conditioning. Regarding our inventions requirement for usefulness, it will contribute to saving human and animal lives by actuating audible and visual warnings to summon help. Our invention is nonobvious. The automotive industry has long used solenoids in their vehicles as has temperature control on fans for decades. Our searches found nothing indicating either component has been used for or as lifesaving devices. Our design uses two primary components, neither of which has been used as life saving devices. Therefore, our invention is non obvious.

Note: The automotive solenoid/relays used in our invention are a standard 5 pin type. There is also a 4 pin type. The difference is the 5 pin has a fifth powered lead that provides an additional, but separate, continual power outlet when the solenoid is actuated. This is useful dependent on the vehicles actuation requirements dependent if the car is off or running. A 4 pin solenoid will perform the same functions, but loses the feature of having an “extra power outlet”. The automotive word, “solenoid/relay”, is generic. Solenoids vary in configuration, size and type, dependent on the vehicle manufactures requirements for higher amperage components like engine starters. We use the standard 5 pin rated for up to 40 amp draw.

### BACKGROUND OF THE INVENTION

From the time records have been kept starting in 1998, this year, 2021, a total exceeding 1000 humans will have died in overheated vehicles, the majority under age 2. A far greater number of pets have died, but accurate records have not been kept. Young persons and pets cannot escape from overheated vehicles being unable to operate the doors and windows. Nor are there records for how many close calls where the medics or firemen saved lives. The medical professions published danger point for heatstroke, leading to death, if unattended, is when a body is subject to a temperature of approximately 120 degrees Fahrenheit. In the Eastern USA States, at 75 F degrees outdoor temperatures, vehicle interiors can reach 120 degrees Fahrenheit temperatures in 15 minutes. In the South and Western States, with temperatures averaging 90 F, the danger point, heatstroke, can occur in less than 5 minutes. Our inventions initial goal was to signal both audible and visual alarms, alerting anyone in the vicinity of the vehicle, seeing and hearing the alarms, would come and render aid. When the USPO granted our invention a provisional patent, we constructed the first prototype/test unit Prior, we bench tested individual components. From the first test and since, our invention has actuated both visual and audible warnings every time without fail. Once proven, this led to exploring and testing of the solenoids other possible control/actuation features. Our initial goal for warnings progressed to one of controlling vehicles components like electric doors, windows and starting air conditioners. The real test that will confirm our testing will be to install prototypes in police vehicles. They have the most on the road experience because their vehicles are often run hard and under severe weather conditions.

Our search for a device to warn of life threatening overheated vehicle interiors began in 2017 when a friend took her pets shopping, stayed too long and on returning to her vehicle, found the pets passed out and on the verge of death due to heatstroke. Firemen were called, applied oxygen and the pets survived. She asked me to find a device for her vehicle that would sound both visual and audible warnings that her car cab was overheating. My search for such a product on the Internet did not find any such devices for sale. A retained patent attorney performed a patent search and selected 20 related issued patents under the category, “hot car deaths”. It is again important to note, none of the patents researched provide a commercial product for sale. This emphasizes the need for our type of invention. Reviews of existing patents related to hot car deaths utilize multiple types of commercially made actuation devices, ranging from pressure sensors, lasers, sound recognition, fire and carbon monoxide devices, phones plus other “safety hardware”. That loading of hardware and related costs, escalates their costs to manufacture, generating a market sales price which the average vehicle owner cannot afford. This was common to most of the patents reviewed. It is important to state again the need and importance of bringing our type of invention to the marketplace. Lives continue to being lost and resolution has given away to economics.

### Example of a DIY Police Retrofit

Two examples were found on the cost of retrofitting vehicles with the desired safety warning features, control of windows and doors including air conditioning. Assembly was by two police departments, Houston, Tex. and Twinsburg, Ohio. They retrofitted their cruisers at costs of $1500.00 to $1800.00 plus labor. Components used by existing patents require technical expertise to install and repair. The Houston and Twinsburg police departments refitted their cruisers to protect their K9 police dogs. When trained, these dogs can cost $10-20,000.00.

There are an estimated 50,000 thousand K9 dogs nationally, whose departmental budgets do not have the monies to retro fit their cruisers to save K9 dogs if trapped. With an optional engine starter component, to provide remote engine start, our invention will perform similar functions at estimated 40 percent less installed cost than the two police departments cited.

*Footnote: The referenced police department, Twinsburg, Ohio, who outfitted the cruiser for their K9 dog, unfortunately made national news by one of the cop's wives winding up and dying in the back seat of an overheated police cruiser. She was in the backseat, alone, the car overheated and she could not get out. Cop cars carry felons in the backseat and the windows and doors cannot be opened from the interior to prevent escape. We could not get more details on why she was left alone. Had she been in the cruiser they outfitted for the K9's, the heat rise would have started the engine and air conditioning, opened the doors and she would have escaped. This tragedy emphasizes the need for our type of warning systems.

### BRIEF DESCRIPTION OF THE DRAWING

The FIGURE shows the power flow and actuation of the components of the invention.

### DETAILED DESCRIPTION OF THE INVENTION

On the issuance of our provisional patent, we progressed from bench testing to a fully operable prototype. It was built to demonstrate and prove that our invention would perform at manufactured costs offering affordable sales prices to the vehicle owners. If our invention is not affordable, it will not make it to market regardless of the benefits. The two main components, a common vehicle relay and a bimetallic fan heat sensor cost a market list price of $15.00 total for both. A cost so inexpensive, the need to repair would cost more than to replace and the operating sequence illustrated in the FIGURE show and explain the control/actuation of power and continuity to components.

A prototype is used to test different components to power/actuate audible and visual alarms and act as continuity devices. Optional temperature sensors, wiring sizes carrying volts/amps for both in vehicle and portable external warning products are being tested. Included have been external visual and audible devices in lieu of connecting to the vehicles existing hazard warning systems. An external strobe flasher for visual warnings and 110 decibel siren are considerations. Existing vehicles hazard warning systems, horns and flashers, have a limited warning potential. There are so many false horn warnings, the public has become immune to investigating the causes.

Our goal is and has been to reduce the cost of our invention, producing lifesaving warning and control device, costing about the same as an installed new car radio. An even lower cost battery operated model to be hung on the vehicle window is being considered, sounding audible and visual warnings. It is under development to provide a low cost warning device that all vehicle owners could afford the safety. Some two years into attempting to come up with affordably market priced product, in the middle of one of my many drawings of control schematics, in 2019, my hobbies in rebuilding cars and electronic devices, had me realize that the standard automotive relay, common to all vehicles, could possibly provide current and continuity controls to turn on visual and audible warnings (our original goal). In our initial bench tests, from a 12 volt source, we wired the bimetallic fan thermostat to the relay and connected a 120 decibel siren and strobe flasher. On raising the temperature to 120 F, the solenoid normally open contacts dosed, actuated the relay, powering the alarms which worked on the first try and ever since. The basic relay control schematic which I drew in 2019, is the same base configuration used for all tests to date. The design with only two primary components is the essence of simplicity, low cost/maintenance yet, it will provide the needed functions to help save lives. With an added optional remote engine starter, our invention when actuated, will start the engine and turn on the vehicle air conditioning. It was shortly after that we applied for and was granted a provisional patent that we used the remote engine starter on my car and hardwired the continuity contacts of the engine auto start component to the continuity contacts of the solenoid. The solenoid was powered and the engine and air conditioner started immediately. Normally a remote engine starter is normally actuated by a hand operated wireless remote control. Another application is using our device with a remote engine starter for a dual purpose. In hot climates, the owner may wish to keep the interior cool to keep food or related from spoiling or to avoid blistering heat on entering the vehicle when the vehicle is parked for short periods. In cold climates, our thermostat could be changed to turn on the heat for a period. Both applications, cold or hot, are set by the cars heating and cooling controls when the engine starts.

### Conclusion

Five years ago, a friend who almost lost her pets in an overheated car, asked me to find a device that would provide both visual and audible warnings to summon help if a vehicle cab became overheated, endangering both human and animal life. I could not find one for sale or on the net. I retained a patent attorney to locate existing granted patents. He provided 20 out of the category, “Deaths in Hot Cars”. On review and Internet search, there were none of the issued patents that either produced or had a product for sale. This was fact five years ago and remains the same today. A needed lifesaving product to save human and animal lives urgently needed.

Long retired and at age 87, I cannot afford a patent attorney to enter this request for a patent. I obtained a provisional patent and did the testing as covered in the specifications to prove our product meets an important need, one that saves lives. When ready to submit for a formal patent, I bought the Nolo book on DIY patent writing and with the support of one of your examiners providing information on pertinent forms and protocols, it is my hope that this this submittal adheres to the rules of the Patent Office as closely as possible. Deaths in overheated vehicles are still occurring daily and will continue until a solution is provided. Any monies that would be generated from my efforts will be donated to a charitable fund. My reward will be to know I left something behind that saved lives.

A patent is required to attract reps to take our invention nationally. They will be spending time and money starting what is a new concept. They require the legal protection of a patent to protect their interests. The need is national in scope, requiring the manpower and capital to bring our invention to market and save lives. Even with approval, bringing our invention to market will take time. We require USPTO approval to turn our testing efforts into reality.

1. A device with two primary repurposed components, an auto solenoid and bimetallic fan temperature switch, when actuated by a vehicles interior cab temperature, turns on audible and visual warning devices to summon help and save humans and animals trapped in hot cars.

2. A bimetallic fan temperature switch on sensing a vehicles cab temperature reaching 120 degrees Fahrenheit doses the contacts and actuates/powers the automotive solenoid.
